(19) United States
(12) Patent Application Publication
(10) Pub. No.: US 2011/0119847 A1
(43) Pub. Date: May 26, 2011

(54) WHEEL AND LUG NUT BRUSH ASSEMBLY

(76) Inventor: Herbert GOMES, Navarre, FL (US)

(21) Appl. No.: 12/624,050

(22) Filed: Nov. 23, 2009

(51) Int. Cl. B60S 3/00

(52) U.S. Cl. 15/114

(57) ABSTRACT

A cleaning device to assist in cleaning wheels and lug nuts comprising: a stem, where said stem includes a first end and a second end; a bristle assembly at the first end; and a sponge at the second end. The bristle assembly may include a base and a plurality of bristles. The base may be circular in shape and the plurality of bristles extend around the perimeter of the base leaving an opening in the inside the perimeter of the bristles. In one exemplary embodiment, the bristles may be evenly spaced and the sponge may be conical shaped with a pointed tip.

### BACKGROUND OF THE INVENTION

1. Field of Invention

The present invention relates to a wheel and lug nut brush assembly utilized to clean wheel and lug nut surfaces of a wheel.

2. Description of Related Art

Vehicle care and maintenance entails mechanical repairs and aesthetic cleaning In terms of aesthetic cleaning, a vehicle must be washed and waxed periodically to maintain the looks and appearance of the vehicle. Washing involves washing the body, windows, wheels and undercarriage of the vehicle. Some individuals take great care in the cleaning and waxing of their vehicle. In particular, some individuals have customized wheels and spokes with unique designs and configurations. The unique designs and configurations of wheels occasionally create a challenge to maintain and clean on a regular basis. Due to the placement of the wheels near brake pads, wheels accumulate a significant amount of brake dust due to the braking of the vehicle. Further depending on driving conditions and weather, wheels may accumulate excessive amounts of salt, dirt and grime, and therefore increase the difficulty in maintaining clean wheels.

The design of the wheel includes a plurality of lugs and crevices that may be associated with the lugs. Commonly special brushes and tools have been designed to reach into the crevices and lug nut openings in order to effectively sponge, wipe and clean the wheels. U.S. Pat. No. 6,754,932 discloses a device for cleaning vehicular lug nuts or lug nut covers and the surfaces of the lug nuts or lug nut cover-receiving receptacles of hubcaps and rims. The device of the '932 patent includes scouring fingers pivotedly mounted on a base member defining a socket for receiving the outer sections of the lug nuts or the entirety of the lug nut covers.

U.S. Pat. No. 5,123,763 discloses a cleaning tool for the removal of debris and subsequent cleaning of lug nuts for a wheel that includes an elongated handle removably mounted to a socket where the socket includes a cylindrical or a conical configuration to receive an associated lug nut bearing.

Although some devices, as noted as noted above, have been developed to address wheel and lug nut cleaning, further development of more optimal cleaning devices is needed. In particular, in addition to providing brushes within a cleaning device, it would be advantageous to also include a sponge attachment to provide a further means for cleaning a lug nut and rim area of a wheel.

### SUMMARY OF THE INVENTION

The present invention relates to a cleaning device to assist in cleaning wheels and lug nuts comprising: a stem, where said stem includes a first end and a second end; a bristle assembly at the first end; and a sponge at the second end. The bristle assembly may include a base and a plurality of bristles. The base may be circular in shape and the plurality of bristles extend around the perimeter of the base leaving an opening in the inside the perimeter of the bristles. In one exemplary embodiment, the bristles may be evenly spaced and the sponge may be conical shaped with a pointed tip.

### BRIEF DESCRIPTION OF DRAWINGS

FIG. 1A depicts a wheel lug nut cleaning assembly according to the present invention.

FIG. 1B depicts a front view of a brush used on the wheel cleaning assembly according to the present invention.

FIG. 2A depicts a front view of a vehicle wheel.

FIG. 2B depicts a sectional view of the wheel of FIG. 2A.

### DETAILED DESCRIPTION

The present invention relates to a wheel and lug nut cleaning device. The cleaning device provides a bristle brush configured to clean a lug nut. The cleaning device according to the present invention further includes a sponge attachment to assist in cleaning the crevices of a wheel.

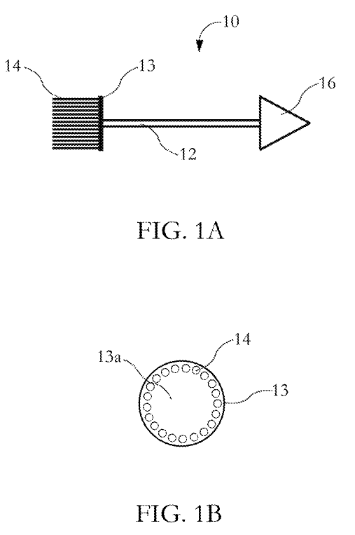

A side view of a Wheel Lug Nut Cleaning Device 10 is depicted in FIG. 1A. The Cleaning Device 10 includes a set of Brush Bristles 14 at a first end thereof and a Sponge 16 at a second end thereof. A Stem 12 connects the Brush Bristles 14 and Sponge 16 together and provides the final component of the Cleaning Device 10. The Brush Bristles 14 are mounted on a Base 13 and are positioned around the perimeter thereof. FIG. 1B provides a front view of the Brush Bristles 14. The Base 13 is substantially circular with the plurality of Bristles 14 surrounding the perimeter thereof. An Opening 13A is provided within the circle of Bristles 14 that therefore allows for the insertion of the lug nut when using the Cleaning Device 10.

The Cleaning Device 10 may be maneuvered and manipulated by holding the Stem 12 and the user thereof may utilize the Bristle Assembly 14 on the lug nut and the crevices surrounding the lug nut. The Sponge 16 is provided at the opposite end thereof to enable the user to reach the crevices and surfaces that may be associated with the wheel that the user is cleaning.

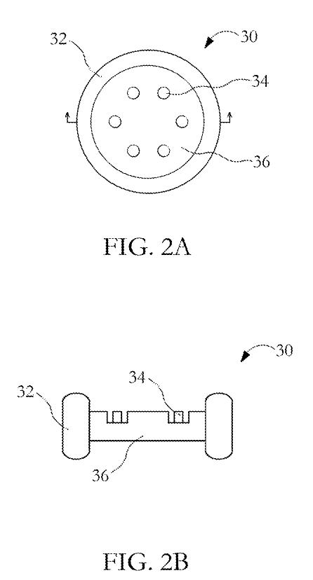

A conventional Wheel 30 is depicted in FIG. 2A. The Wheel 30 includes a Tire 32 and a plurality of Lug Nuts 34 within the Rim 36. A cross-section view of the Wheel 30 is provided in FIG. 2B. The cross-section provides a clear view of the crevice created by a Lug Nut 34 that may be reached by the Bristles 14 of the Cleaning Device 10. The Wheel 30 is provided as an example of a typical wheel that may be cleaned with the Cleaning Device 10. A multitude of wheel designs exist in the prior art. The Cleaning Device 10 is however uniquely suited for the various angles and crevices that may be existing on a vehicle wheel. The Bristles 14 are uniquely designed to address the lug nuts that are shown on the conventional wheel. The Sponge 16 is provided as a means to reach crevices near, around and surrounding the lug nut and the rim body assembly as needed. In one particular embodiment of the present invention, the Sponge 16 may be shaped in a conical shape with a pointed tip as depicted in FIG. 1A. The configuration of the Sponge 16 however may vary and may be configured to suit specific configurations of wheels. The Sponge 16 may be circular, concaved or convexed in shape in order to reach certain areas of the wheel assembly.

The cleaning device according to the present invention assists in cleaning rims of various configurations and accommodates wheel lug nuts enabling the user to reach between the spokes to remove debris collected on the rim. The Brush Bristles 14 according to the present invention may be manufactured of nylon bristles to provide a gentle but effective mechanism to clean the wheel nut crevices. By including the sponge attachment at the opposite end of the cleaning device a user is provided with a means to reach awkward and difficult angles and positions that may be created due to a rim design.

What is claimed is:

1. A cleaning device to assist in cleaning wheels and lug nuts comprising:
a. a stem, where said stem includes a first end and a second end;
b. a bristle assembly at the first end; and
c. a sponge at the second end.

2. The cleaning device according to claim 1, where said bristle assembly include a base and a plurality of bristles.

3. The cleaning device according to claim 2, where said base is circular in shape and said plurality of bristles extend around the perimeter of the base leaving a opening in the inside the perimeter of the bristles.

4. The cleaning device according to claim 3, wherein said plurality of bristles are evenly spaced.

5. The cleaning device according to claim 1, wherein said sponge is a conical shape with a pointed tip.

6. The cleaning device according to claim, wherein said sponge is shaped in at least one of a circular, concaved and convexed shaped.
